(19) United States
(12) Patent Application Publication
(10) Pub. No.: US 2009/0300620 A1
(43) Pub. Date: Dec. 3, 2009

(54) CONTROL DEVICE AND METHOD FOR PROVIDING USER INTERFACE (UI) THEREOF

(75) Inventors: Eun-hee PARK, Suwon-si (KR); Seung-dong YU, Osan-si (KR); Woo-yong CHANG, Yongin-si (KR); Ju-il EOM, Suwon-si (KR); Chang-hwan HWANG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/388,258

(22) Filed: Feb. 18, 2009

(30) Foreign Application Priority Data
May 27, 2008 (KR) 10-2008-0049247

(51) Int. Cl. G06F 3/048; G06F 9/46

(52) U.S. Cl. 718/100; 715/825

(57) ABSTRACT

A control device which displays menus generated based on tasks is provided. The control device includes an input unit which receives a user command for performing a task, and a control unit which, if a task to be performed is selected via the input unit, generates a menu list showing menus for each of a plurality of apparatuses available to perform the selected task. Therefore, it is possible for a user to conveniently perform a desired task.

### CROSS-REFERENCE TO RELATED APPLICATIONS

This application claims priority from Korean Patent Application No. 10-2008-0049247, filed on May 27, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a control device and providing a user interface (UI) of the control device, and more particularly, to providing a control device which displays menus generated based on tasks and providing a UI of the control device.

2. Description of the Related Art

As a result of the rapid development of video and audio media technologies, various types of apparatuses are capable of being connected to home networks.

When users desire to connect network connectable apparatuses to televisions, they need to manually connect physical cables and register apparatuses or perform other operations. To make up for this, methods complying with the high definition multimedia interface (HDMI)-consumer electronics control (CEC) have been proposed, but users need to perform initial settings and only the connection state for each apparatus is displayed.

Additionally, when a user desires to use the apparatus connected to the network, only information regarding whether the apparatus is connected is displayed, so it is difficult for the user to perform a desired task because he or she may not know which apparatus is associated with which task.

Furthermore, if several apparatuses are required to perform the desired task, remote controllers for each apparatus are also required to manipulate the apparatuses. In this situation, as each of the remote controllers includes a direct key in the form of a button, the number of buttons may increase, thereby causing confusion to the user.

Moreover, each of the remote controllers has a button to perform the same function for each apparatus, so a user may be confused about which remote controller he or she should use when manipulating the apparatus.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a control device which displays a menu based on tasks, and a method for providing a user interface (UI) thereof.

According to an aspect of the present invention, there is provided a control device comprising an input unit which receives a user command for performing a task; and a control unit which, if a task to be performed is selected via the input unit, generates a menu list showing menus for each of a plurality of apparatuses available to perform the selected task.

The control device may further comprise a display unit which displays the menu list. The control unit may classify menus required for performing the selected task among the menus in the menu list according to the type of apparatus or according to the functions of each of the plurality of apparatuses, and may generate the menu list.

The display unit may display a task list or an apparatus list showing apparatuses available to perform the selected task.

The control unit may collect profiles from each of a plurality of apparatuses in a home network, and may form a group of apparatuses available for performing tasks from among the plurality of apparatuses based on the collected profiles.

If at least one task is selected, the control unit may control operations of apparatuses available to perform the selected task so that the apparatuses may perform the selected task.

If a new profile collected from at least one of the plurality of apparatuses differs from an existing profile, the control unit may update the existing profile.

If a new apparatus is connected on the home network, the control unit may collect a profile from the new apparatus and form another group of apparatuses.

The control unit may classify apparatuses required for performing tasks according to a preset list of tasks, based on the collected profiles.

The control unit may check the collected profiles, determine which task is able to be performed, and classify apparatuses available to perform the tasks.

The task may be at least one of watching TV, watching a recorded program, playing back a disk, listening to the radio, listening to music, viewing still images, viewing moving images, and turning on and off all apparatuses.

According to an aspect of the present invention, there is provided a method for providing a user interface (UI), the method comprising receiving a user command for performing a task; and if a task to be performed is selected in response to the user command, generating a menu list showing menus for each of a plurality of apparatuses available to perform the selected task.

The method may further comprise displaying the menu list. The generating may comprise classifying menus required for performing the selected task among the menus in the menu list according to the type of apparatus or according to the functions of each of the plurality of apparatuses, and generating the menu list.

The method may further comprise displaying a task list; and displaying an apparatus list showing apparatuses available to perform the selected task.

The method may further comprise collecting profiles from each of a plurality of apparatuses in a home network; and forming a group of apparatuses available for performing tasks from among the plurality of apparatuses, based on the collected profiles.

The method may further comprise, if at least one task is selected, controlling operations of apparatuses available to perform the selected task so that the apparatuses may perform the selected task.

The method may further comprise, if a new profile collected from at least one of the plurality of apparatuses differs from an existing profile, updating the existing profile.

The method may further comprise, if a new apparatus is connected on the home network, collecting a profile from the new apparatus and forming another group of the list of apparatuses.

Apparatuses required for performing tasks may be classified according to a preset list of tasks, based on the collected profiles.

The forming may comprise checking the collected profiles, determining which task is able to be performed, and classifying apparatuses available to perform the tasks.

The task may be at least one of watching TV, watching a recorded program, playing back a disk, listening to the radio, listening to music, viewing still images, viewing moving images, and turning on and off all apparatuses.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a control device according to an exemplary embodiment of the present invention;

FIG. 2 is a block diagram of a control device according to another exemplary embodiment of the present invention;

FIGS. 3 and 4 exemplarily illustrate a home network system comprising the control device shown in FIG. 2;

FIGS. 5A and 5B exemplarily illustrate a task list according to an exemplary embodiment of the present invention;

FIGS. 6A to 6C exemplarily illustrate various display patterns according to an exemplary embodiment of the present invention;

FIGS. 7A to 9 exemplarily illustrate in detail various display patterns shown in FIGS. 6A to 6C.

FIG. 10 is a flowchart illustrating a method for providing a user interface (UI) of a control device according to an exemplary embodiment of the present invention;

FIG. 11 is a flowchart illustrating a method for providing a UI of a control device according to another exemplary embodiment of the present invention; and

FIG. 12 is a flowchart illustrating a method for providing a UI of a control device according to still another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

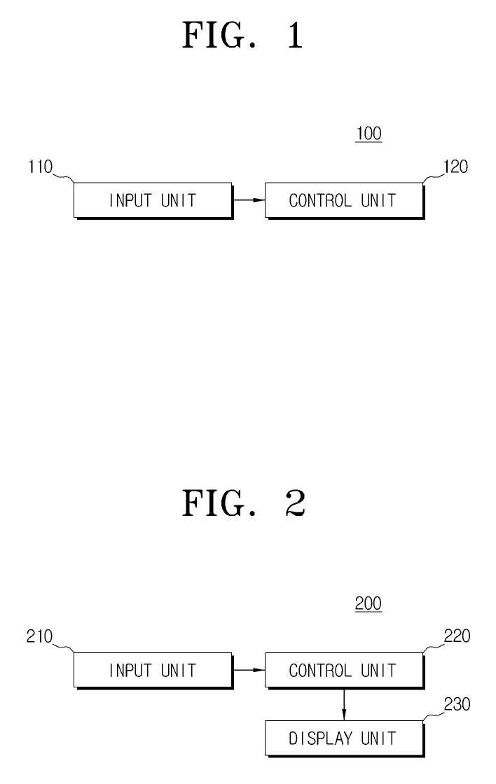

FIG. 1 is a block diagram of a control device 100 according to an exemplary embodiment of the present invention.

The control device 100 of FIG. 1 comprises an input unit 110 and a control unit 120. The control device 100 may be implemented as a digital television (DTV) or a remote controller.

For example, if the control device 100 is a remote controller, the remote controller may bi-directionally communicate with a plurality of apparatuses within a home network, and may directly control each of the plurality of apparatuses, so that each of the plurality of apparatuses may transmit its own information to the remote controller. Here, bi-directional communication covers not only all existing communication technologies, such as Bluetooth (BT), radio frequencies (RF), wireless fidelity (Wi-Fi), high definition multimedia interface (HDMI)-consumer electronics control (CEC) or wireless HDMI-CEC, but also bi-directional communication technologies which may be developed in the future.

Alternatively, if the control device 100 is a remote controller capable of controlling a plurality of apparatuses connected to a DTV, the DTV may bi-directionally communicate with the plurality of apparatuses. In other words, the remote controller may control the DTV, so the plurality of apparatuses connected to the DTV may be controlled.

Additionally, if the control device 100 is a DTV on a home network, the DTV may bi-directionally communicate with a plurality of apparatuses on the home network, and may control the plurality of apparatuses so as to receive information regarding the plurality of apparatuses from each of the plurality of apparatuses.

The input unit 110 receives user commands to perform at least one task. Here, tasks can be performed by the plurality of apparatuses in the home network, and may include, for example, watching TV, watching a recorded program, playing back a disk, listening to the radio, listening to music, viewing still images, viewing moving images, or turning on and off all apparatuses.

Such tasks may be previously set, or may be generated based on profiles collected from each of the plurality of apparatuses in the home network. For example, if a TV, digital video disk player (DVDP) and home theater system (HTS) are connected to the home network, tasks such as watching the TV and watching a DVD that can be performed by the TV, DVDP or HTS may be created.

The control unit 120 generates a menu list showing only menus required to perform tasks from among a plurality of menus contained in each of the plurality of apparatuses available to perform tasks selected through the input unit 110.

Additionally, the control unit 120 collects profiles from each of the plurality of apparatuses, and forms a group of apparatuses available for performing a task among the plurality of apparatuses based on the collected profiles. Here, the plurality of apparatuses may include a TV, a set-top box (STB), an HTS, a blue-ray disc player (BDP), a DVDP, a hard disc drive recorder (HDDR), a portable multimedia player (PMP), a digital camera (DSC) or other apparatuses capable of being connected over the home network. The BDP is a high-density optical disc player capable of recording a disc with a capacity of tens of gigabytes (GB) or greater. Additionally, each of the profiles may comprise information regarding a manufacturer or function of the respective apparatus.

If a user selects some tasks using the input unit 110, the control unit 120 controls the operation of apparatuses available so that the apparatuses may perform the selected tasks. For example, if the user selects ‘watching a recorded program’, and if the TV and HDDR are available to perform the selected task, the control unit 120 controls the TV and HDDR so that the selected task may be automatically performed.

If there is a new profile collected from at least one of the plurality of apparatuses that is different from the existing profile, the control unit 120 updates the existing profile.

Additionally, if a new apparatus is connected to the home network, the control unit 120 collects a profile from the new apparatus, and forms another group of apparatuses based on the collected profile.

The control unit 120 classifies the apparatuses required to perform tasks according to the type of preset tasks, based on the collected profiles.

The control unit 120 checks the collected profiles, determines which task is able to be performed, and classifies apparatuses used to perform the tasks.

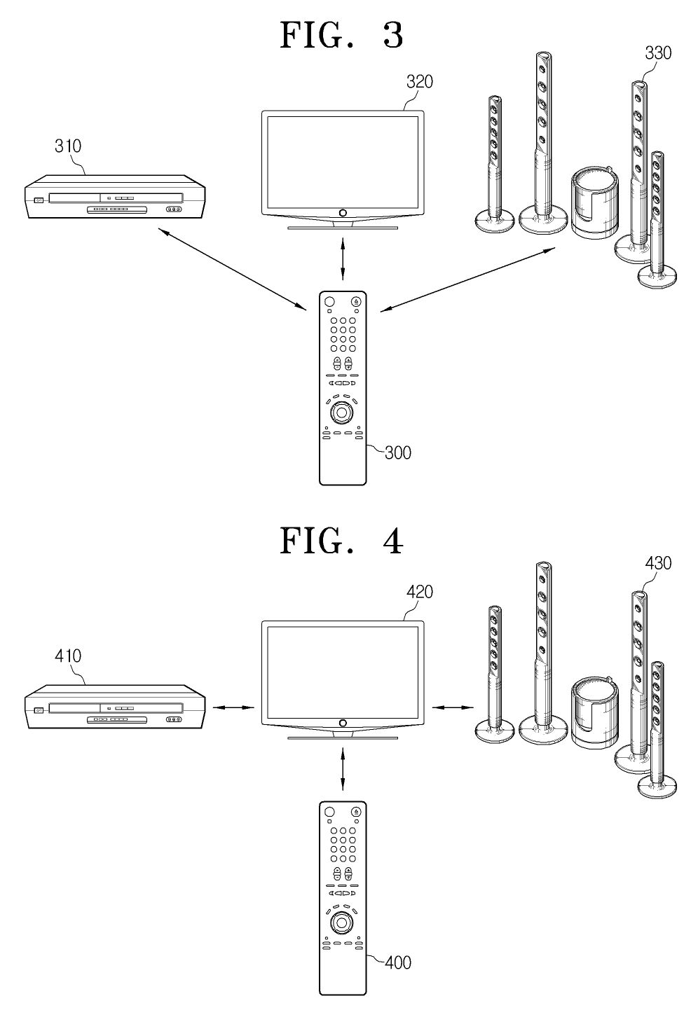

FIG. 2 is a block diagram of a control device 200 according to another exemplary embodiment of the present invention. The control device 200 of FIG. 2 comprises an input unit 210, control unit 220 and display unit 230. No further detailed description of components overlapping between the control device 100 of FIG. 1 and control device 200 of FIG. 2 is provided.

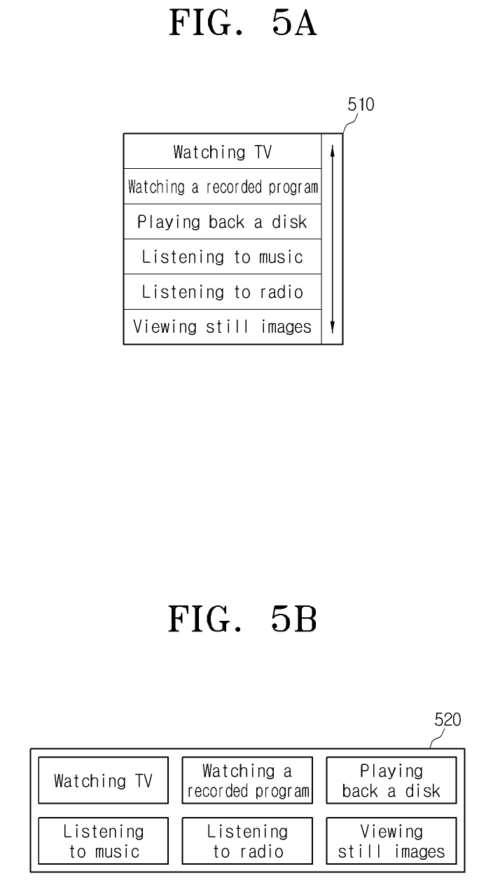

The display unit 230 displays a menu list generated by the control unit 220. The display unit 230 may be implemented as a DTV 320, as shown in FIG. 3, or as a liquid crystal display (LCD) contained in a remote controller 400, as shown in FIG. 4. Additionally, the display unit 230 may be, for example, a cathode-ray tube (CRT), plasma display panel (PDP) or organic light emitting diode (OLED) according to the situation.

The control unit 220 classifies menus, required for performing tasks among menus for each of the plurality of apparatuses available to perform a task selected through the input unit 210, according to the type of apparatus or according to the functions of the respective apparatus, and controls the display unit 230 to display a menu list containing the classified menus. For example, if the user selects ‘playing back a disk’, and if a TV, BDP and HTS are able to assist in performing the selected task, menus required for playing back a disk among menus for the TV, BDP and HTS may be classified according to the type of apparatus and a menu list containing the classified menus may be displayed on the display unit 230. Alternatively, in this situation, the menus required for playing back a disk may be classified according to their function, and a menu list containing the menus may be displayed on the display unit 230. While the menus in the menu list displayed on the display unit 230 are classified according to the type of apparatus or according to the functions of the respective apparatus, the present invention is applicable to a situation in which menus are arranged by various classification criteria other than the type of apparatus and the type of function.

The display unit 230 displays a task list. In more detail, the display unit 230 displays a preset task list or a task list created based on the profiles collected from each of the plurality of apparatuses in the home network, so that a user is able to select desired tasks from the displayed task list. The displayed task list may be configured in the form of soft keys, through which a user is able to select tasks by touching the display unit 230. Additionally, the displayed task list may be provided with buttons included in the control device 200.

The display unit 230 displays an apparatus list showing apparatuses available to perform tasks selected via the input unit 210. For example, if the user selects ‘playing back a disk’, and if a TV, BDP and HTS are available to perform the selected task, the display unit 230 may display an apparatus list containing the TV, BDP and HTS. In this situation, the display unit 230 may concurrently display a task list including selected tasks and an apparatus list including apparatuses corresponding to the selected tasks, or may display only the apparatus list.

The control device 200 may further comprise a storage unit (not shown) which stores a task list, an apparatus list including apparatuses required for performing tasks in the task list, and a menu list including menus for each of the apparatuses in the apparatus list.

FIGS. 3 and 4 exemplarily illustrate a home network system comprising the control device 200 of FIG. 2.

In a home network system shown in FIG. 3, the control device 200 of FIG. 2 is implemented as a remote controller 300, and a plurality of apparatuses on a home network, namely a BDP 310, TV 320 and HTS 330, are able to perform bidirectional communication. Accordingly, it is possible to collect profiles from each of the plurality of apparatuses and generate tasks, or to generate an apparatus list or a menu list.

In a home network system shown in FIG. 4, the control device 200 of FIG. 2 is implemented as a remote controller 400 or a TV 420. Here, the TV 420 may communicate bi-directionally with other apparatuses on a home network, namely a BDP 410 and HTS 430.

If the control device 200 is implemented as a remote controller 400, the TV 420 may collect profiles from the BDP 410 and HTS 430, and transmit the collected profiles to the remote controller 400. The remote controller 400 may receive the profiles, form a group of apparatuses and create a menu list.

Alternatively, if the control device 200 is the TV 420, the TV 420 may collect profiles from the BDP 410 and HTS 430, form a group of apparatuses and create a menu list. The remote controller 400 may only receive user commands and transmit the user commands to the TV 420.

While three apparatuses are connected on the home network in the exemplary embodiment of the present invention, there is no limitation to the number of apparatuses capable of being connected to the home network. Additionally, the home network systems shown in FIGS. 3 and 4 have been provided to explain the relationship between the apparatuses and control device over the home network, so no further detailed description of the remote controller (for example, a display unit of the remote controller) is required.

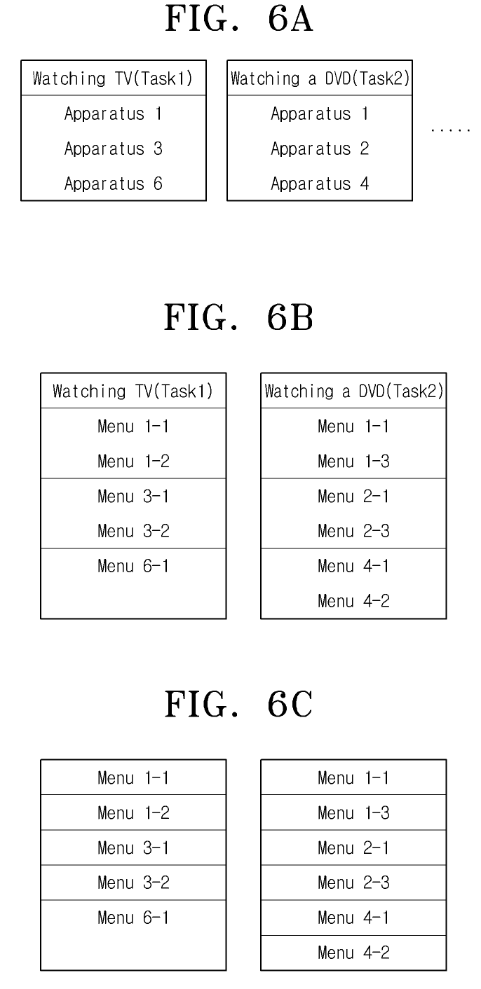

FIGS. 5A and 5B exemplarily illustrate a task list according to an exemplary embodiment of the present invention.

In FIG. 5A, a task list 510 is displayed on the display unit 230 of the control device 200. For example, the task list 510 may be displayed on a screen of a TV or a display screen of a remote controller. If the task list 510 is displayed on the display screen of the remote controller, the task list 510 may be configured in the form of software buttons which a user is able to touch.

In FIG. 5B, a task list 520 is provided in the form of keys or buttons in a handheld device, such as a remote controller. While the handheld device is merely an example for convenience of description, the task list 520 may be implemented in the form of keys or buttons in a DTV according to the situation.

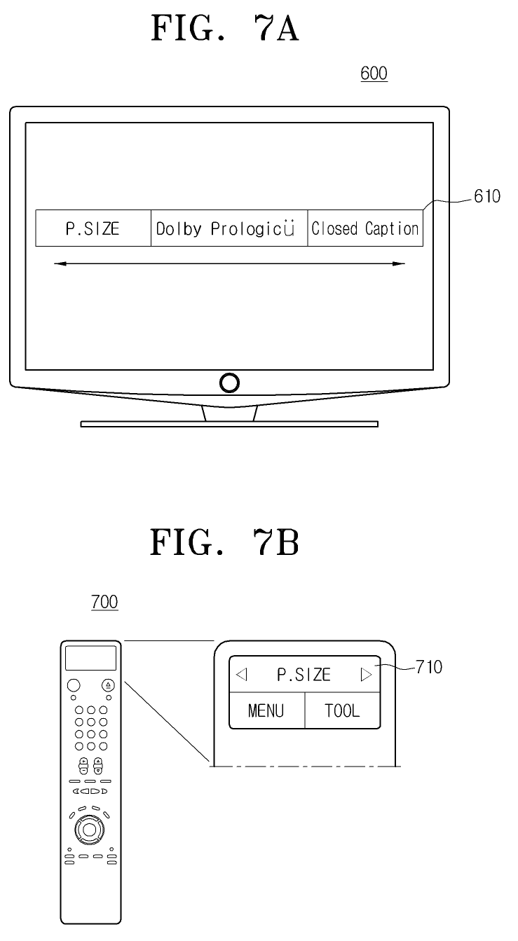

FIGS. 6A to 6C exemplarily illustrate various display patterns according to an exemplary embodiment of the present invention.

In FIG. 6A, if the user selects ‘watching TV’, namely Task 1, a list of apparatuses for performing Task 1, that is Apparatus 1, Apparatus 3, Apparatus 6, may be displayed. Additionally, if the user selects ‘watching a DVD’, namely Task 2, a list of apparatuses for performing Task 2, that is Apparatus 1, Apparatus 2, Apparatus 4, may be displayed.

In FIG. 6B, if the user selects Task 1, menus of Apparatus 1, Apparatus 3, and Apparatus 6 to perform Task 1 may be displayed together with Task 1. The menus may be menus 1-1 and 1-2 required by Apparatus 1, menus 3-1 and 3-2 required by Apparatus 3 and menu 6-1 required by Apparatus 6. Additionally, if the user selects Task 2, menus of Apparatus 1, Apparatus 2, and Apparatus 4 to perform Task 2 may be displayed together with Task 2. The menus may be menus 1-1 and 1-3 required by Apparatus 1, menus 2-1 and 2-3 required by Apparatus 2 and menus 4-1 and 4-2 required by Apparatus 4.

Alternatively, as shown in FIG. 6C, only the menus required by Apparatuses 1 to 6 to perform the corresponding tasks may be displayed, except for the apparatus list and task list.

While the menus of the apparatuses for performing a task are classified and displayed according to the type of apparatus in the exemplary embodiment of the present invention, this is merely an example for convenience of description. Accordingly, the menus of the apparatuses may be classified and displayed according to the functions of the respective apparatus regardless of the type of apparatus.

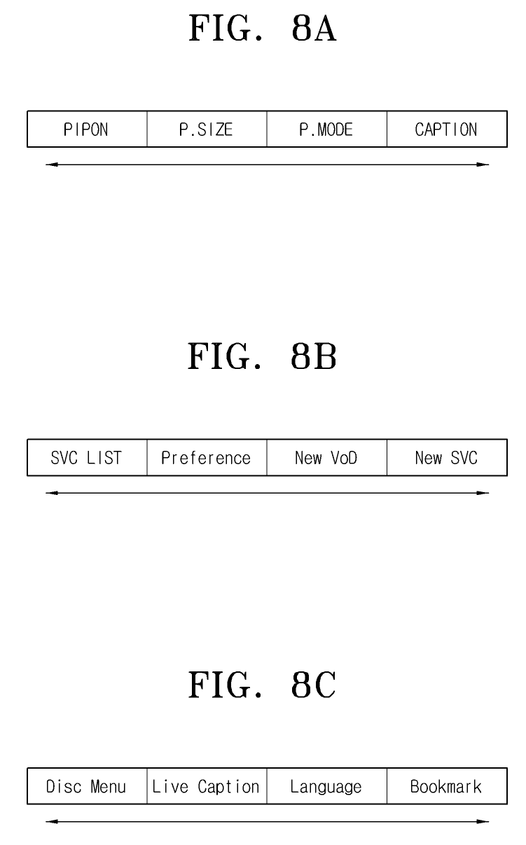

FIGS. 7 to 9 exemplarily illustrate in detail various display patterns shown in FIGS. 6A to 6C.

In FIG. 7A, a menu required to perform the selected task is displayed on a display unit 610 of a TV 600. For example, if the user selects ‘playing back a disk’, and if a TV, BDP and HTS are available to perform the selected task, the display unit 600 may simultaneously display ‘Picture Size (P.SIZE)’, ‘Dolby Prologic II’ and ‘Closed Caption’ corresponding to a TV menu, an HTS menu and a BDP menu, respectively.

In FIG. 7B, a menu required to perform the selected task is displayed on a display unit 710 of a remote controller 700.

FIGS. 8A to 8C exemplarily illustrate various menus to be displayed on the display unit 710 of the remote controller 700.

The menus shown in FIGS. 8A to 8C respectively comprise menus required by apparatuses for performing tasks ‘watching TV’, ‘watching Internet Protocol (IP) TV’ and ‘watching a DVD’.

When ‘P.SIZE’ is displayed as shown in FIG. 7B, if a user inputs a command using the input unit 210 such as directional keys or a control key, ‘Picture Mode (P.MODE)’ following ‘P.SIZE’ may be displayed in response to the command, as shown in FIG. 8A.

FIG. 9 shows a control device 900 having a four-line display unit 910. In order to perform the selected task, ‘Picture Size’ and ‘Picture Mode’ actuated by the TV, and ‘Sound Mode’ and ‘Dolby Prologic II’ actuated by the HTS may be displayed on the display unit 910 simultaneously.

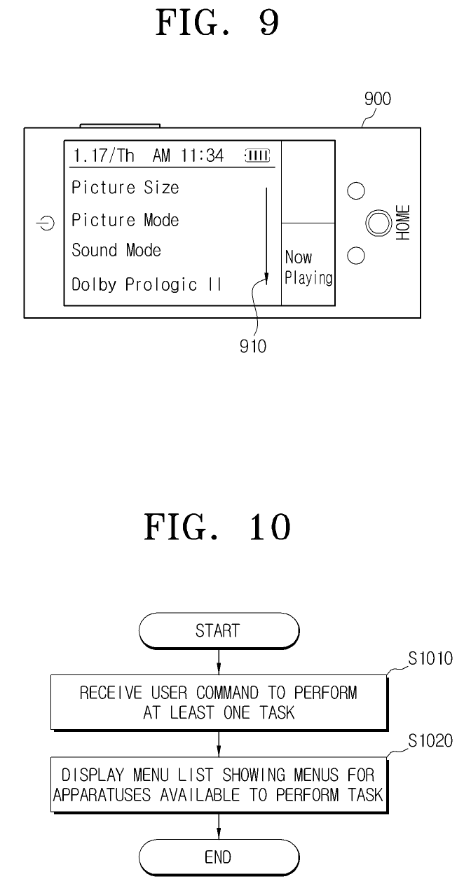

FIG. 10 is a flowchart illustrating a method for providing a UI of a control device according to an exemplary embodiment of the present invention.

In FIG. 10, the control device receives a user command to perform at least one task (S1010). If at least one task is selected in response to the user command, a menu list showing menus of apparatuses available to perform the selected task may be displayed (S1020).

In operation S1020, only menus required to perform the selected task from the displayed menu list may be displayed, according to the type of apparatus.

Additionally, a task list or an apparatus list containing the apparatuses required for performing the selected task may be displayed.

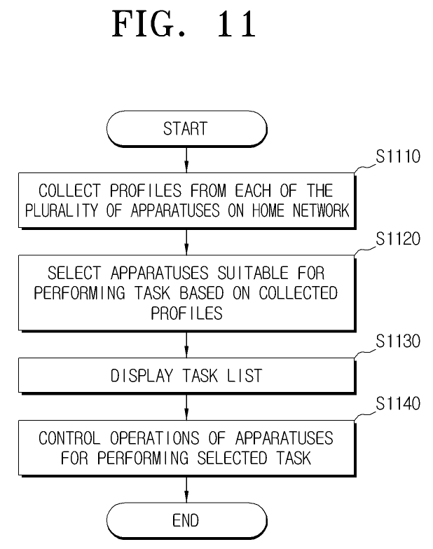

FIG. 11 is a flowchart illustrating a method for providing a UI of a control device according to another exemplary embodiment of the present invention.

In FIG. 11, if profiles are collected from each of a plurality of apparatuses within a home network (S1110), the control device forms a group of apparatuses suitable for performing tasks from among the plurality of apparatuses based on the collected profiles (S1120).

Subsequently, a task list is displayed (S1130).

If a single task is selected from the task list, the control device controls apparatuses suitable for performing the selected task, so that the selected task may be performed (S1140).

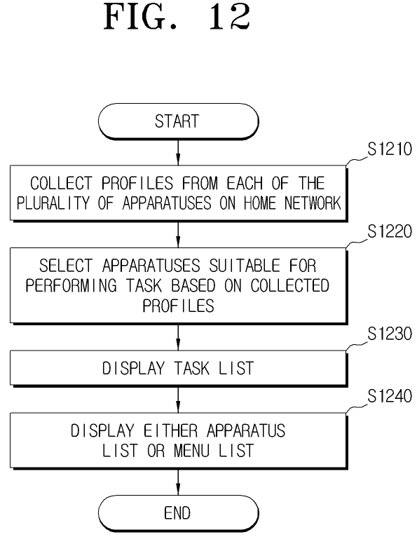

FIG. 12 is a flowchart illustrating a method for providing a UI of a control device according to still another exemplary embodiment of the present invention.

In FIG. 12, if profiles are collected from each of a plurality of apparatuses within a home network (S1210), the control device forms a group of apparatuses suitable for performing tasks from among the plurality of apparatuses based on the collected profiles (S1220).

Subsequently, a task list is displayed (S1230).

If a single task is selected from the task list, either an apparatus list showing apparatuses required for performing the selected task or a menu list showing menus of the apparatuses in the apparatus list may be displayed (S1240).

Here, the task list may be pre-set, so it is possible to classify apparatuses required for performing tasks according to the preset task list based on the collected profiles.

Additionally, the task list may be generated based on profiles collected from each of the plurality of apparatuses in the home network. Accordingly, the control unit may check the collected profiles, determine which task is able to be performed, and classify apparatuses used to perform the tasks.

Tasks in the task list may be at least one of watching TV, watching a recorded program, playing back a disk, listening to the radio, listening to music, viewing still images, viewing moving images, and turning on and off all apparatuses.

Furthermore, if a new apparatus is connected to the home network, the control device may collect a profile from the new apparatus and may form another group of the apparatuses based on the collected profile.

As described above, according to an exemplary embodiment of the present invention, a single control device may control a plurality of apparatuses, and provide menus based on tasks, so user convenience may increase.

Additionally, a plurality of apparatuses may be connected over a network, taking into consideration tasks performed by a user, so it is possible to provide a user with concurrent use of the plurality of apparatuses with greater convenience.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A control device comprising:
an input unit which receives a user command for performing a task; and
a control unit which, if a task to be performed is selected via the input unit, generates a menu list showing menus for each of a plurality of apparatuses available to perform the selected task.

2. The control device as claimed in claim 1, further comprising a display unit which displays the menu list,
wherein the control unit classifies menus required for performing the selected task among the menus in the menu list according to a type of apparatus or according to functions of each of the plurality of apparatuses, and generates the menu list.

3. The control device as claimed in claim 2, wherein the display unit displays a task list or an apparatus list showing apparatuses available to perform the selected task.

4. The control device as claimed in claim 1, wherein the control unit collects profiles from each of a plurality of apparatuses in a home network, and forms a group of apparatuses available for performing tasks from among the plurality of apparatuses based on the collected profiles.

5. The control device as claimed in claim 4, wherein, if at least one task is selected, the control unit controls operations of apparatuses available to perform the selected task so that the apparatuses perform the selected task.

6. The control device as claimed in claim 4, wherein, if a new profile collected from at least one of the plurality of apparatuses differs from an existing profile, the control unit updates the existing profile.

7. The control device as claimed in claim 4, wherein, if a new apparatus is connected on the home network, the control unit collects a profile from the new apparatus and forms another group of apparatuses.

8. The control device as claimed in claim 4, wherein the control unit classifies apparatuses required for performing tasks according to a preset list of tasks, based on the collected profiles.

9. The control device as claimed in claim 4, wherein the control unit checks the collected profiles, determines which task is able to be performed, and classifies apparatuses available to perform the tasks.

10. The control device as claimed in claim 1, wherein the task is at least one of watching TV, watching a recorded program, playing back a disk, listening to a radio, listening to music, viewing still images, viewing moving images, and turning on and off all apparatuses.

11. A method for providing a user interface (UI), the method comprising:
receiving a user command for performing a task; and
if a task to be performed is selected in response to the user command, generating a menu list showing menus for each of a plurality of apparatuses available to perform the selected task.

12. The method as claimed in claim 11, further comprising displaying the menu list,
wherein the generating comprises classifying menus required for performing the selected task among the menus in the menu list according to a type of apparatus or according to functions of each of the plurality of apparatuses, and generating the menu list.

13. The method as claimed in claim 12, further comprising:
displaying a task list; and
displaying an apparatus list showing apparatuses available to perform the selected task.

14. The method as claimed in claim 11, further comprising:
collecting profiles from each of a plurality of apparatuses in a home network; and
forming a group of apparatuses available for performing tasks from among the plurality of apparatuses, based on the collected profiles.

15. The method as claimed in claim 14, further comprising:
if at least one task is selected, controlling operations of apparatuses available to perform the selected task so that the apparatuses perform the selected task.

16. The method as claimed in claim 14, further comprising:
if a new profile collected from at least one of the plurality of apparatuses differs from an existing profile, updating the existing profile.

17. The method as claimed in claim 14, further comprising:
if a new apparatus is connected on the home network, collecting a profile from the new apparatus and forming another group of the list of apparatuses.

18. The method as claimed in claim 14, wherein apparatuses required for performing tasks are classified according to a preset list of tasks, based on the collected profiles.

19. The method as claimed in claim 14, wherein the forming comprises checking the collected profiles, determining which task is able to be performed, and classifying apparatuses available to perform the tasks.

20. The method as claimed in claim 11, wherein the task is at least one of watching TV, watching a recorded program, playing back a disk, listening to a radio, listening to music, viewing still images, viewing moving images, and turning on and off all apparatuses.
